(19) United States
(12) Patent Application Publication
(10) Pub. No.: US 2012/0175975 A1
(43) Pub. Date: Jul. 12, 2012

(54) SWITCHED RELUCTANCE MOTOR

(75) Inventors: Han Kyung Bae, Gyunggi-do (KR); Chee Woo Lee, Gyunggi-do (KR); Tae Ho Yun, Gyunggi-do (KR)

(73) Assignee: SAMSUNG ELECTRO-MECHANICS CO., LTD., Gyunggi-do (KR)

(21) Appl. No.: 13/269,282

(22) Filed: Oct. 7, 2011

(30) Foreign Application Priority Data
Jan. 10, 2011 (KR) 1020110002437

(51) Int. Cl. H01R 39/44; H02K 37/02

(52) U.S. Cl. 310/46; 310/241

(57) ABSTRACT

Disclosed is herein a switched reluctance motor including: a rotor; commutators connected to both ends of the rotor; brushes mechanically contacting to the commutators by rotation of the rotor; a stator having the brushes fixed thereto and having stator poles having coils wound therearound, wherein the brushes are moved and mounted by an advance angle from a connection axis of stator poles opposite to each other, wherein the advance angle is a region between application of a voltage and rise of an inductance and a dwell angle, a voltage application period is controlled by arc angles of the commutator and the brush.

### CROSS REFERENCE TO RELATED APPLICATION

This application claims the benefit of Korean Patent Application No. 10-2011-0002437, filed on Jan. 10, 2011, entitled “Switched Reluctance Motor”, which is hereby incorporated by reference in its entirety into this application.

### BACKGROUND OF THE INVENTION

1. Technical Field

The present invention relates to a switched reluctance motor.

2. Description of the Related Art

A general switched reluctance motor has a magnetic structure in which both of a stator and a rotor are a salient pole. In addition, the stator has a concentrated winding coil wound therearound, and the rotor is formed of only an iron core without using any excitation device (e.g., a winding, a permanent magnet, or the like) to have excellent price competitiveness. Further, a speed changeable switched reluctance motor may stably generate a continuous torque with the aid of a converter using a power semiconductor and a position sensor, and may be easily controlled according to performance required for each application.

Even though the switched reluctance motor is inexpensive due to a simple rotor structure, it has problems in that it should use a converter formed of a semiconductor switch in order to generate a reluctance torque, has an increased cost of the entire system, and should include an expensive control circuit capable of performing rapid processing in order to appropriately perform a control during rapid driving thereof.

A universal motor mainly used in fields such as a cleaner, an electric tool, or the like, uses a commutator and a brush, which are a simple mechanical structure, to generate a torque without using the converter and the position sensor, and has been widely used in the above fields due to an advantage of having an inexpensive motor structure rather than improving performance by the control. However, in the universal motor, the coil is wound around the rotor as well as the stator, which causes increase in a material cost and copper loss of the rotor, thereby reducing efficiency of the motor. Therefore, it is difficult to use the universal motor in a high-end type model requiring high efficiency.

FIG. 1 is a schematic configuration diagram of a switched reluctance motor according to the prior art. The switched reluctance motor 100 of which only a single phase is shown in FIG. 1 includes a rotor 110, a stator 120 formed with a stator pole 121, and a coil 130 wound around the stator pole 121. When a current is applied to the coil, a magnetic field is generated in the stator pole, and an attractive force is generated between the stator pole 121 and the rotor 110 to rotate the rotor 110.

In addition, when a plurality of phase windings are wound around a plurality of stator poles, the phase windings of the stator poles are excited one by one to generate a torque, thereby rotating the rotor. In this case, since position feedback of the rotor is required, a position sensor is required, and a converter formed of a power semiconductor is also required in order to apply a current to the winding of the stator according to the position of the rotor. In addition, a controller having a digital signal processor (DSP), a microcontroller unit (MCU), or the like, mounted therein is required for complicated and rapid processing.

As described above, since the switched reluctance motor according to the prior art should necessarily include the converter, the controller, and the position sensor for driving thereof, it may not be implemented at a low cost, has a deteriorated degree of freedom in design due to a complicated technical configuration, and has a high possibility for a fault or an error.

### SUMMARY OF THE INVENTION

The present invention has been made in an effort to provide a switched reluctance motor in which a torque performing mechanical phase conversion is generated by using a commutator and a brush without using a converter and a position sensor, thereby making it possible to be implemented by a simple mechanical structure at a low cost.

Further, the present invention has been made in an effort to provide a switched reluctance motor in which an advance angle and a dwell angle having a direct influence on performance of a motor is controlled by changing a position and arc angles of a commutator and a brush, thereby making it possible to perform a design according to an optimal operation point (maximal efficiency, maximal torque, or the like), and respective positive torque regions generated in two pairs of stator poles are controlled using the design method to change an overlapping torque, thereby making it possible to perform a design so as to reduce a torque ripple.

Further, the present invention has been made in an effort to provide a switched reluctance motor in which transient voltage suppressions (TVSs) connected to coils of each phase is included and an energy stored in an inductance is exhausted as heat through the TVS, such that generation of a negative torque is prevented and forced phase conversion is generated.

According to a first preferred embodiment of the present invention, there is provided a switched reluctance motor including: a rotor; commutators connected to both ends of the rotor; brushes mechanically contacting to the commutators by rotation of the rotor; a stator having the brushes fixed thereto and having stator poles having coils wound therearound, wherein the brushes are moved and mounted by an advance angle from a connection axis of stator poles opposite to each other.

The advance angle may be a region between application of a voltage and rise of an inductance, and a dwell angle, a voltage application period may be controlled by arc angles of the commutator and the brush.

The coils wound around the poles may be an A phase winding and a B phase winding, respectively.

The switched reluctance motor may further include TVSs each connected to both ends of the A phase winding and the B phase winding.

One pair of two pairs of brushes each connected to the A phase winding and the B phase winding may be connected to a power supply and the other pair thereof may be connected to the coil.

The dwell angle may be defined as d=X+2Y, where X indicates an arc angle of the brush and Y indicates an arc angle of the commutator.

The stator and the rotor may be a salient pole type.

### BRIEF DESCRIPTION OF THE DRAWINGS

FIG. 1 is a schematic configuration diagram of a switched reluctance motor according to the prior art;

FIG. 2 is a schematic configuration diagram of a switched reluctance motor according to a preferred embodiment of the present invention;

FIG. 3 is a schematic circuit diagram of a switched reluctance motor according to a preferred embodiment of the present invention;

FIG. 4 is a graph showing an inductance according to a position of a rotor in a switched reluctance motor according to a preferred embodiment of the present invention;

FIG. 5 is a graph showing an applied voltage according to a position of a rotor in a switched reluctance motor according to a preferred embodiment of the present invention;

FIG. 6 is a usage state diagram showing setting of an advance angle and a dwell angle according to positions of a commutator and a brush in a switched reluctance motor according to a preferred embodiment of the present invention;

FIG. 7 is a schematic usage state diagram according to A phase coil excitation in a switched reluctance motor according to a preferred embodiment of the present invention;

FIG. 8 is a schematic usage state diagram according to A phase and B phase coil excitation in a switched reluctance motor according to a preferred embodiment of the present invention; and

FIG. 9 is a schematic usage state diagram according to B phase coil excitation after A phase conversion in a switched reluctance motor according to a preferred embodiment of the present invention.

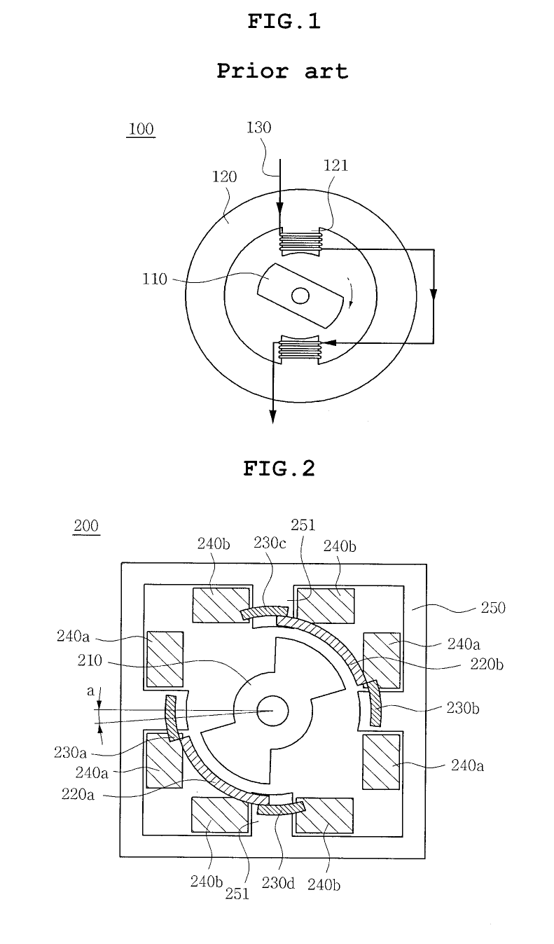

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted.

Hereinafter, a switched reluctance motor according to preferred embodiments of the present invention will be described in detail with reference to the accompanying drawings.

FIG. 2 is a schematic configuration diagram of a switched reluctance motor according to a preferred embodiment of the present invention. As shown in FIG. 2, the switched reluctance motor 200 is configured to include a rotor 210, commutators 220a and 220b, brushes 230a, 230b, 230c, and 230d, coils 240a and 240b, and a stator 250.

More specifically, the commutators 220a and 220b are connected to both ends of the rotor 210, and are short-circuited to each other.

In this configuration, the rotor is connected to the two commutators 220a and 220b so that a central axis thereof coincides with those of the two commutators 220a and 220b. In addition, the stator 250 and the rotor 210 are a salient pole type.

Further, the brushes 230a, 230b, 230c, 230d are provided in two pairs and are fixed to the stator 250, wherein each pair of brushes is opposite to each other, and the stator 250 includes two pairs of stator poles 251, wherein each pair of stator poles is opposite to each other. Two phase coils 240a and 240b are respectively wound around the stator poles.

The brushes mechanically contact the commutators 220 by rotation of the rotor 210. In addition, the brushes 230a, 230b, 230c and 230d are moved and mounted by an advance angle a from a connection axis of the stator poles 251 opposite to each other counterclockwise.

Through the above-mentioned configuration, the commutators 220a and 220b having the same axis as that of the rotor 210 are rotated together with the rotation of the rotor 210. When the commutators 220a and 220b are positioned at a position at which an A phase winding shown as the coil 240a should be excited, they, respectively, mechanically contact the brushes 230a and 230b, such that a current flows, and when the commutators 220a and 220b are positioned at a position at which a B phase winding shown as the coil 240b should be excited, they mechanically contact the brushes 230c and 230d, respectively, such that the current flows.

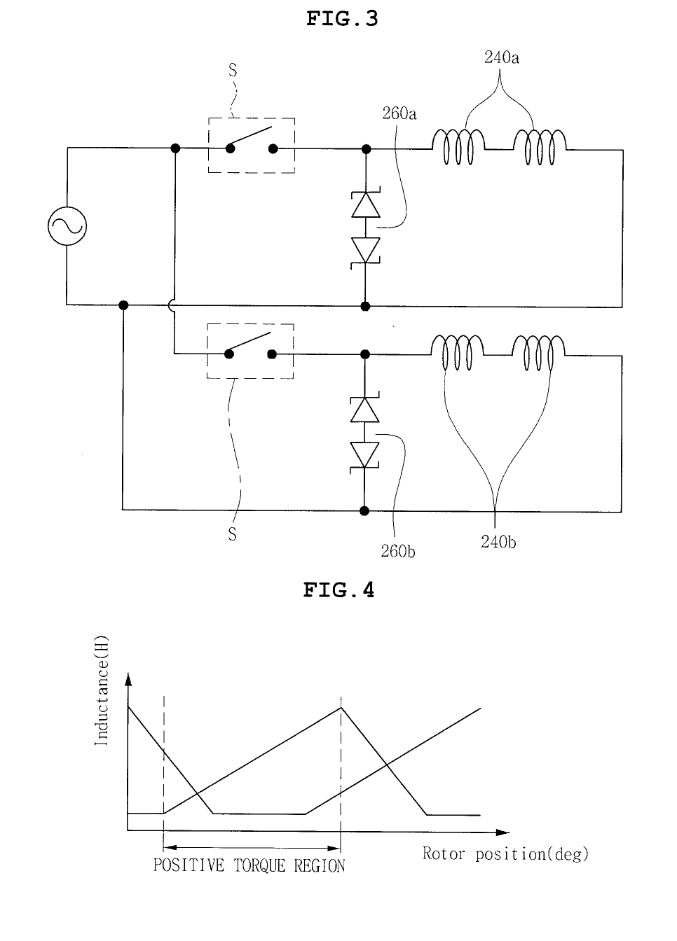

FIG. 3 is a schematic circuit diagram of a switched reluctance motor according to a preferred embodiment of the present invention. As shown in FIG. 3, a switched reluctance motor according to a preferred embodiment of the present invention includes transient voltage suppressions (TVSs) 260a and 260b connected between a switch S operated by an electrical connection between the commutator and the brush and the wound coils 240a and 240b of each phase. In addition, an energy stored in an inductance is exhausted as heat through the TVSs 260a and 260b, such that generation of a negative torque is prevented and forced phase conversion is generated.

Hereinafter, a structure and an operating principle of the switched reluctance motor according to a preferred embodiment of the present invention configured as described above will be described in detail.

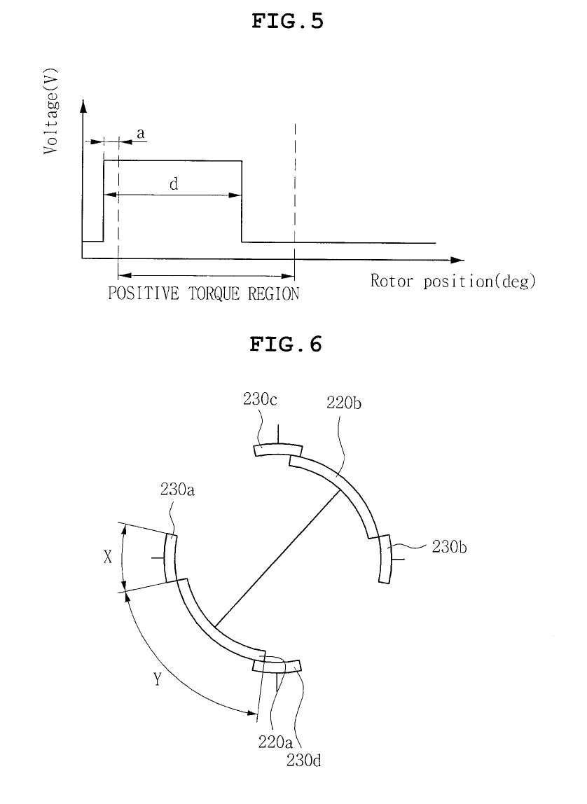

FIG. 4 is a graph showing an inductance according to a position of a rotor in a switched reluctance motor according to a preferred embodiment of the present invention; FIG. 5 is a graph showing an applied voltage according to a position of a rotor in a switched reluctance motor according to a preferred embodiment of the present invention; and FIG. 6 is a usage state diagram showing setting of an advance angle and a dwell angle according to positions of a commutator and a brush in a switched reluctance motor according to a preferred embodiment of the present invention. As shown in FIGS. 4 to 6, a desired current value is not immediately reached during application of a voltage, and a current is not immediately removed during turnoff of the voltage, due to characteristics of an inductance. Therefore, it is important to design the advance angle a for building-up a current and a dwell angle for turning off the voltage off before a negative torque is generated in a minimal inductance period. It is possible to implement roles of the position sensor and the converter according to the prior art through this.

More specifically,

$$T ( θ , i ) = \frac{1}{2} {i}^{2} \frac{d L ( θ )}{d θ} ,$$

where T indicates a torque, θ indicates a position of a rotor, i indicates a phase current, and L indicates an inductance.

As may be appreciated from the above equation, a torque is determined by a generated current and a change rate of an inductance.

Therefore, the advance angle indicate a region between the application of the voltage and rise of the inductance, the voltage is applied by the advance angle a, and the inductance then rises, such that a positive torque region is formed. A voltage application period, which is the dwell angle d, is controlled by an arc angle X of the brush and an arc angle Y of the commutators. As a result, the dwell angle is defined as d=X+2Y, where X indicates the arc angle of the brush and Y indicates the arc angle of the commutator.

Hereinafter, torque generation and phase conversion of the switched reluctance motor according to a preferred embodiment of the present invention will be described in detail.

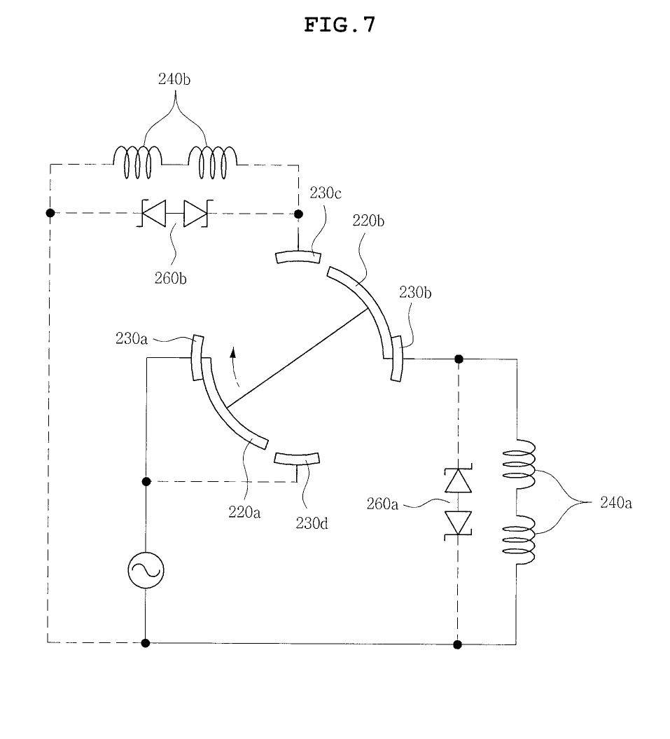

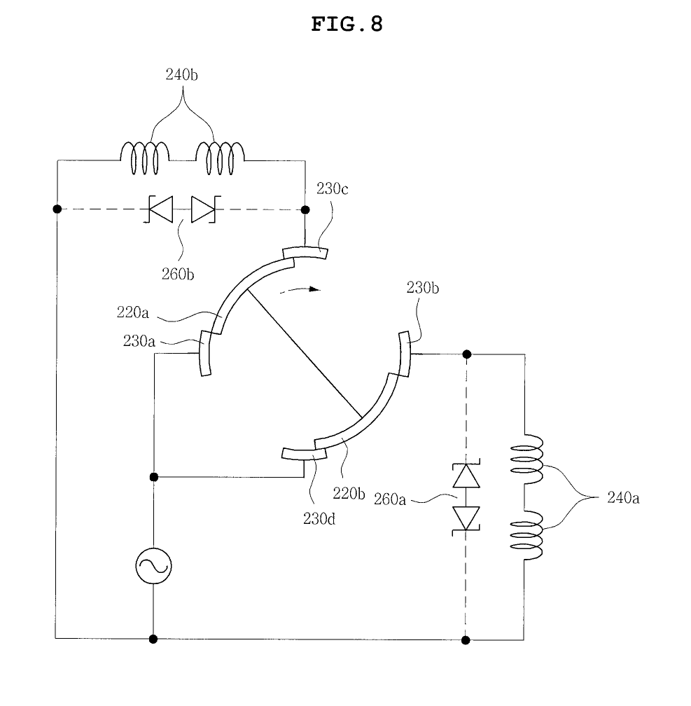

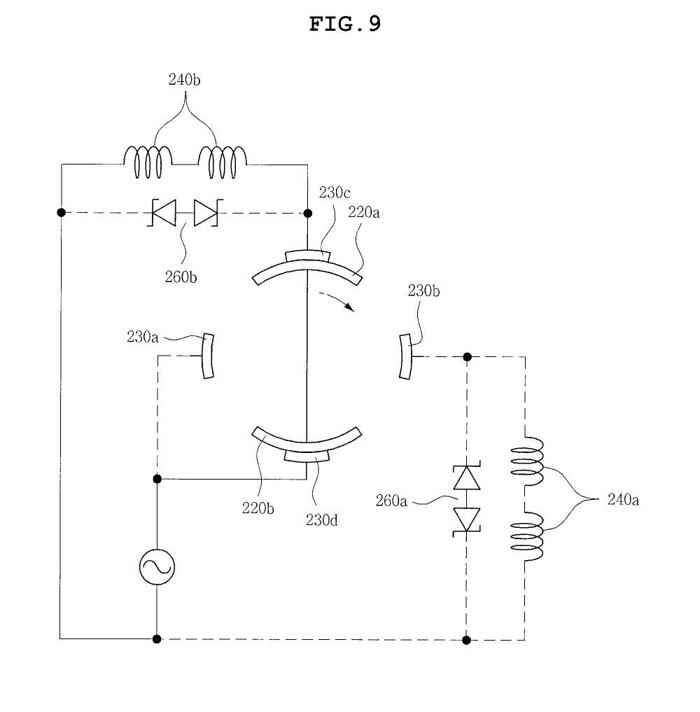

FIG. 7 is a schematic usage state diagram according to A phase coil excitation in a switched reluctance motor according to a preferred embodiment of the present invention; FIG. 8 is a schematic usage state diagram according to A phase and B phase coil excitation in a switched reluctance motor according to a preferred embodiment of the present invention; and FIG. 9 is a schematic usage state diagram according to B phase coil excitation after A phase conversion in a switched reluctance motor according to a preferred embodiment of the present invention.

As shown in FIGS. 7 to 9, the commutators 220a and 220b respectively contact the brushes 230a and 230b, such that a voltage is applied to the commutators and a current flows in the coil 240a, which is the A phase. In this case, since the applied voltage is an alternating current voltage, voltages applied to both ends of the commutators 220a and 220b may have different polarities, that is, a (+) voltage may applied to the commutator 220a and a (−) voltage may applied to commutator 220b or the (−) voltage may applied to the commutator 220a and the (+) voltage may be applied to commutator 220b. In addition, the switched reluctance motor according to a preferred embodiment of the present invention may be operated by a direct current voltage instead of the alternating current voltage.

The commutators 220a and 220b are rotated clockwise to contact all of the upper/lower and left/right brushes 230a, 230b, 230c, and 230d. The A phase coil 240a and the B phase coil 240b are simultaneously excited, and phase conversion is then generated. In addition, when the commutators 220a and 220b are rotated to be disconnected from the upper/lower and the left/right brushes 230a, 230b, 230c and 230d, the energy stored in an A phase magnetic circuit is exhausted as heat through the TVS 260a, such the phase conversion of the A phase is generated before a negative torque region. Through the above-mentioned configuration, the excitation and the freewheeling of the current are controlled to generate a continuous positive torque without a negative torque, and respective positive torque regions generated in two pairs of stator poles are controlled to change an overlapping torque, thereby making it possible to perform a design so as to reduce a torque ripple.

As shown in FIG. 9, when the commutator 220a and 220b contact only the upper/lower brushes 230c and 230d, both of the A phase and the B phase are excited and the phase conversion of the B phase is generated. In addition, when the commutators 220a and 220b are disconnected from the upper/lower brushes 230c and 230d, the energy stored in a B phase magnetic circuit is exhausted as heat through the TVS 260b, such that the phase conversion of the B phase is generated before the negative torque region.

FIGS. 7 to 9 have shown a process in a rotating period of the rotor of 0 to 180 degrees, and the same process as described above with reference to FIGS. 7 to 9 is repeated in a rotating period of the rotor of 180 to 360 degrees.

Through the above-mentioned configuration, in the switched reluctance motor according to a preferred embodiment of the present invention, the advance angle and the dwell angle are controlled by the arc angles of the commutator and the brush and the energy stored in the inductance is exhausted as the heat through the TVS, thereby making it possible to prevent generation of the negative torque.

With the switched reluctance motor according to the preferred embodiment of the present invention, the torque performing mechanical phase conversion is generated by using the commutator and the brush without using the converter and the position sensor, thereby making it possible to be implemented by a simple mechanical structure at a low cost. In addition, the advance angle and the dwell angle having a direct influence on performance of the motor is controlled by changing the position and the arc angles of the commutator and the brush, thereby making it possible to perform a design according to an optimal operation point (maximal efficiency, maximal torque, or the like), and respective positive torque regions generated in two pairs of stator poles are controlled using the design method to change an overlapping torque, thereby making it possible to perform a design to as to reduce a torque ripple. Further the transient voltage suppressions (TVSs) connected to the coil of each phase are included and the energy stored in the inductance is exhausted as heat through the TVS, such that generation of a negative torque is prevented and forced phase conversion is generated.

Although the preferred embodiments of the present invention have been disclosed for illustrative purposes, they are for specifically explaining the present invention and thus a switched reluctance motor according to the present invention is not limited thereto, but those skilled in the art will appreciate that various modifications, additions and substitutions are possible, without departing from the scope and spirit of the invention as disclosed in the accompanying claims.

Accordingly, such modifications, additions and substitutions should also be understood to fall within the scope of the present invention.

What is claimed is:

1. A switched reluctance motor comprising:
a rotor;
commutators connected to both ends of the rotor;
brushes mechanically contacting to the commutators by rotation of the rotor;
a stator having the brushes fixed thereto and having stator poles having coils wound therearound,
wherein the brushes are moved and mounted by an advance angle from a connection axis of stator poles opposite to each other.

2. The switched reluctance motor as set forth in claim 1, wherein the advance angle is a region between application of a voltage and rise of an inductance.

3. The switched reluctance motor as set forth in claim 1, wherein a dwell angle, a voltage application period is controlled by arc angles of the commutator and the brush.

4. The switched reluctance motor as set forth in claim 1, wherein the coils wound around the poles are an A phase winding and a B phase winding, respectively.

5. The switched reluctance motor as set forth in claim 4, further comprising TVSs each connected to both ends of the A phase winding and the B phase winding.

6. The switched reluctance motor as set forth in claim 4, wherein one pair of two pairs of brushes each connected to the A phase winding and the B phase winding is connected to a power supply and the other pair thereof is connected to the coil.

7. The switched reluctance motor as set forth in claim 3, wherein the dwell angle is defined as d=X+2Y, where X indicates an arc angle of the brush and Y indicates an arc angle of the commutator.

8. The switched reluctance motor as set forth in claim 1, wherein the stator and the rotor are a salient pole type.
